(19) United States
(12) Patent Application Publication
(10) Pub. No.: US 2009/0013005 A1
(43) Pub. Date: Jan. 8, 2009

(54) FILE OR DIRECTORY NAME GENERATION METHOD AND DEVICE THEREOF

(75) Inventor: Po-Chieh Hung, Tokyo (JP)

Correspondence Address: CANTOR COLBURN, LLP, 20 Church Street, 22nd Floor, Hartford, CT, 06103, US

(73) Assignee: KONICA MINOLTA HOLDINGS, INC., Tokyo (JP)

(21) Appl. No.: 11/816,481

(22) PCT Filed: Feb. 14, 2006
(86) PCT No.: PCT/JP2006/302487

§ 371 Date: Aug. 16, 2007

(30) Foreign Application Priority Data
Feb. 24, 2005 (JP) 2005-048600

(51) Int. Cl. G06F 17/30

(52) U.S. Cl. 707/200; 707/E17.01

(57) ABSTRACT

A name generation method for generating a name to be assigned to a file or directory including the step of combining date information identifiable to a user with ID code including the time information for specifying the time of processing, said time information being set on the upper node side bit.

### TECHNICAL FIELD

The present invention relates to a file or directory name generation method and a device thereof.

### BACKGROUND

A great variety of photograph related services have been provided in recent years. For example, a user employs a digital camera to take a photograph. The digital camera or medium recording the image file of the photograph are then brought to a photo shop such as a Minilab, wherein the image file is read from the digital camera or medium by a recording apparatus, and is written into a recording medium such as a CD-R. The resulting product is then handed over to the user.

In this case, the image file is copied to the recording medium using the same file name or directory name as those of the digital camera or medium. In the digital camera, the file name or directory name are assigned according to a predetermined standard (DCF: Design Rule for Camera File System). When an image file acquired by a plurality of digital cameras is to be copied to a recording medium, the file name or directory name may overlap with each other. To avoid such a problem, the Unexamined Japanese Patent Application Publication No. 2000-78507 proposes a method, wherein a digital camera is provided with a file name assigning unit, which is used to generate a file name including the information on the manufacturer and digital camera type.

Patent Document 1: Unexamined Japanese Patent Application Publication No. 2000-78507 (FIG. 2 on pp. 2-3)

### DISCLOSURE OF THE INVENTION

### Problems to be Solved by the Invention

When the method of the aforementioned Patent Document 1 is used, there is no overlap among the file names even if the image files photographed by a plurality of digital cameras having different manufacturers and model names are recorded on one recording medium. However, there will be an overlap among the file names if the image files photographed by a plurality of digital cameras having the same manufacturers and model names are recorded on one recording medium. Such a problem occurs also when the image files recorded on a plurality of recording media are to be recorded on one and same recording medium or when a new image file is added to the hard disk already containing a record of another image file.

When there is an overlap between the file or directory names, one of the overlapping file or directory names has to be changed. If a desired name is assigned to the file or directory regularity will be lost when a series of files is rearranged, with the result that file management will become difficult.

If a long name is designated to avoid an overlap between file or directory names, the usability will be impaired—for example, part of the name may not be displayed on the screen or the much time may be taken for rearrangement. If an attempt is made to give such a long name automatically by the recording apparatus, the file or directory name generating device will be overloaded, and the service activities at the Minilab or photo shop will be adversely affected.

The aforementioned problem is not limited to the image file photographed by a digital camera; it occurs to the image file photographed by a mobile phone equipped with a camera, the image file obtained by scanning the film or photographic print, and the other electric file than the image file.

The major object of the present invention is to solve the aforementioned problem and to provide a file or directory name generation method and a device thereof, wherein this name generation method easily generates a file or directory name that can be clearly identified from the names of other files or directories, such a name being easily managed and utilized.

### Means for Solving the Problems

To achieve the aforementioned object, the name generation method of the present invention is a method of generating a name to be assigned to a file or directory, and is characterized in that the date information identifiable to the user, and the ID code wherein the time information for specifying the time of processing are included in the upper node side bit are combined to generate the aforementioned name.

Further, the name generation device of the present invention is a device for generating a name to be assigned to a file or directory, and is equipped with at least one name generation device, characterized in that the date information identifiable to the user and the ID code wherein the time information for specifying the time of processing are included in the upper node side bit are combined to generate the aforementioned name.

### EFFECTS OF THE INVENTION

The file or directory name generation method and device thereof in the present invention provide the following advantages:

The first advantage of the present invention substantially reduces the possibility of the file or directory names being overlapped with each other, and this advantage ensures reliable copying of the file and directory. This is because the present invention generates the name to be assigned to the file or directory through the combination between the date information identifiable to the user, such as the imaging date of the image file associated with the file or directory and the file or directory generation date, and the ID code made up of the information inherent to the apparatus such as the time information for specifying the time of processing, MAC address manufacturer code and equipment code.

The second advantage of the present invention offers easy management of the file and directory. This is because the time information is set on the upper node side bit of the ID code, and this provides association between chronological sequence and lexicographic sequence. This feature allows a plurality of files to be arranged in chronological sequence.

The third advantage of the present invention enhances usability and reduces the load of the name generation device. This is because the name generated by the aforementioned method is a short name made of 20 bytes or less, except for the extension. This feature allows the entire file or directory name to be displayed by a display unit, cuts down the rearrangement time, and simplifies the process of computation for generation.

### BRIEF DESCRIPTION OF THE DRAWINGS

FIG. 1 is a block diagram representing the structure of the name generation device as an example of the present invention;

FIG. 2 is a schematic diagram showing a recording apparatus equipped with the name generation device as an example of the present invention;

FIG. 3 is a flow chart showing a name assignment procedure using the name generation device as an example of the present invention;

FIG. 4 is a flow chart showing an ID code generation procedure using the name generation device as an example of the present invention;

FIG. 5 is a diagram showing an example of the file recording structure in a hard disk and recording medium; and

FIG. 6 is a diagram showing another example of the file recording structure in a hard disk and recording medium.

### DESCRIPTION OF REFERENCE NUMERALS

1. Name generation device
2. Asset input unit
3. Name generation unit
4. Storage device
5. Clock unit
6. Equipment ID storage unit
7. Recording apparatus
8. Digital camera
9. Mobile phone with camera
10. Medium
11. Recording medium
12. Hard disk
13. Communications network
14. Server

### BEST MODES FOR CARRYING OUT THE INVENTION

As described above with reference to the conventional art, a file name is generated according to the DCF rule from the image file obtained by the digital camera. In the DCF, the file or directory of the same name is generated every time, overlapping file or directory names are produced with a considerable probability. Thus, if there are overlapping names, the user will change the name or the apparatus will change it automatically. If the user assigns names, regularity will be lost from the name of the image file, with the result that management will be difficult.

When the name is changed automatically, as described in the Patent Document 1, even if information on the manufacturer or the model of the digital camera is used, overlapping file names will be produced with a considerable probability when the image file of the same manufacturer or the same mode of the digital camera is copied. Such an overlap can be avoided by generating a unique name. For example, the UUID (Universally Unique Identifier) can be utilized to generate the name.

This UUID is the 128-bit data generated from the date data, MAC address (ID number inherent to the Media Access Control Address Ethernet (registered trademark) card) or random number. When this UUID is converted into the ASCII format, very long data such as “4ae1a8d7-eabc-11d8-3388-0811211c9a55” will be obtained. It cannot be easily displayed if used directly as a file name, and a long rearrangement time will be required. Further, the contents of the file (time of photographing the image file) cannot be estimated from the file name, thus, the usability is impaired. Further, if such a name is generated every time, a heavy load will be imposed on the file or directory name generation unit, with the result that the service activities at the Minilab or photo shop will be adversely affected.

Conversely, when the name has been generated simply by using the time information (e.g., second or sub-second), overlapping file or directory names will be produced with a high degree of probability, if there is a great amount of data having been processed and created on the same date. If, for example, a file name of “OR20050203_{—}09302023” (at 9:30:20.32 on Feb. 3, 2005) has been generated, “OR20050203_{—}09302024”, “ . . . 25”, “ . . . 26”, and “ . . . 27” will be obtained when the name of the file of the image photographed after that time is incremented. If there is data starting from “OR20050203_{—}09302026” having been processed on the same date on a separate machine, the same file name will be produced, and a collision of file names will occur.

Such a problem occurs when parallel processing is carried out in an concentrated photofinishing lab using a plurality of machines. To be more specific, when the name is generated using only the time data, the same file names tend to be produced, if the parallel processing is made by another machine of the photofinishing lab. Further, although the time information differs according to the operating system of a computer, the accuracy is only 1/100 second in the Windows (registered trademark), and is only 1/1000 second in the Unix (registered trademark).

Thus, the present invention provides a method of easily generating the easy-to-use names which are not easily overlapped easily, and which can be managed easily, without much load imposed on the name generation device. According to this method, files or directories are generated using the date information which is associated with the file or directory and which is easily identified by the user, and the ID code including the time information for specifying the time of processing, and the time information is set on the upper node side bit of the ID code. This procedure provides the names wherein the possibility of overlapping is reduced, as compared to the method of using only the time information, and ensures association between the chronological sequence and lexicographic sequence, with the result that file management is facilitated. Further, the method of the present invention provides a shorter name than when the UUID or the like is used. This feature enhances usability and reduces the load on the name generation device.

### EXAMPLES

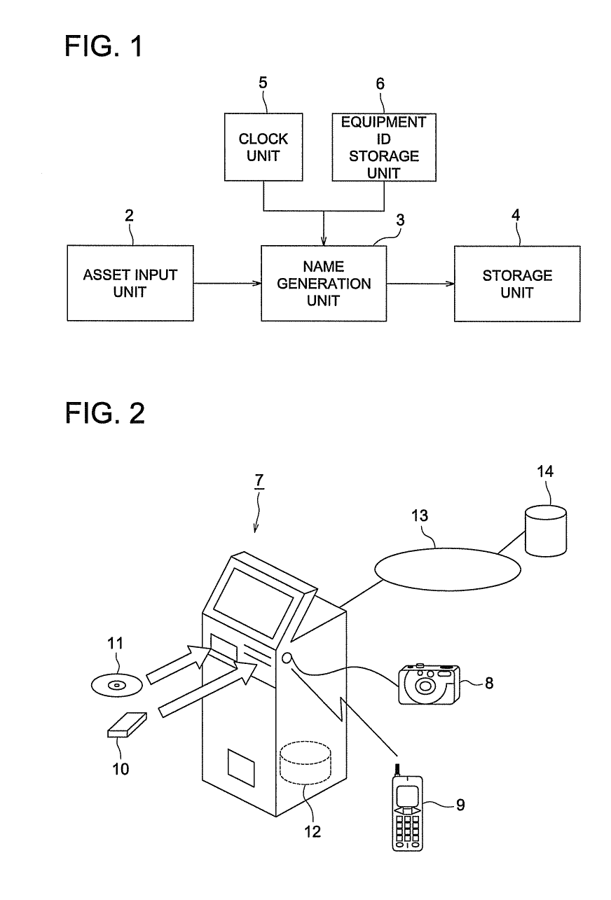

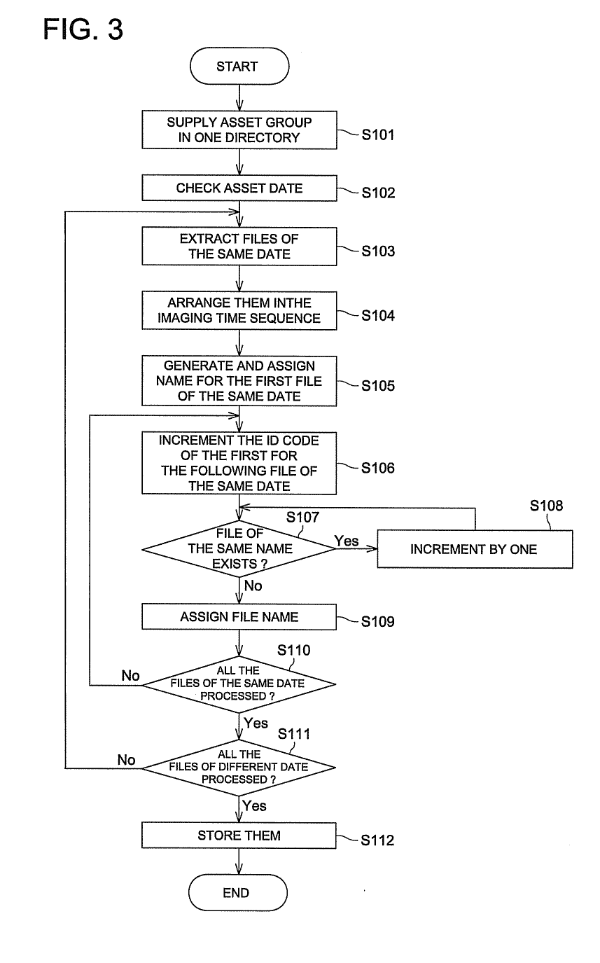

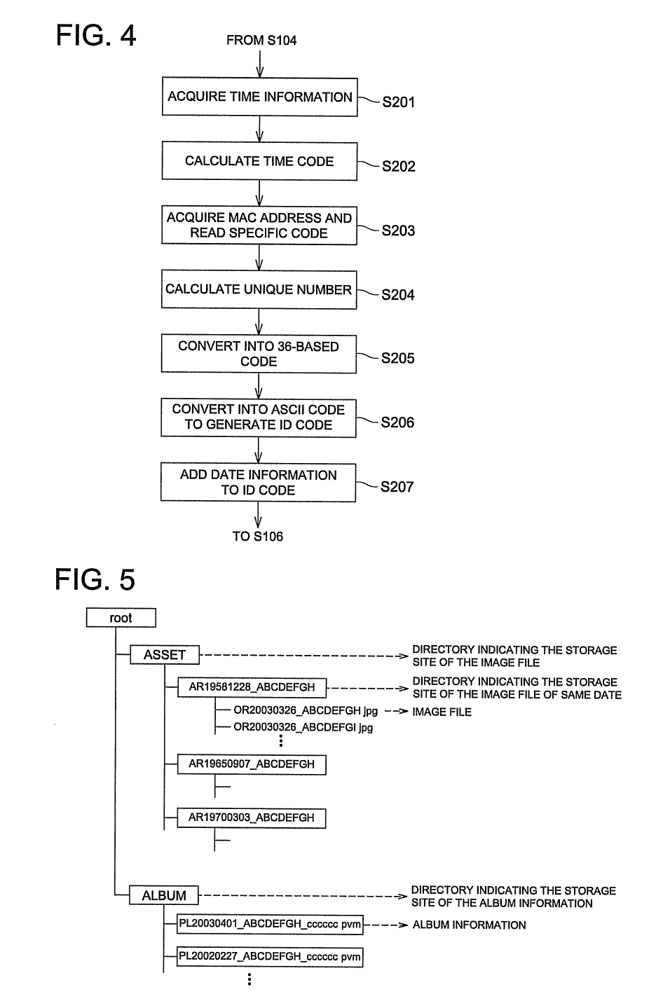

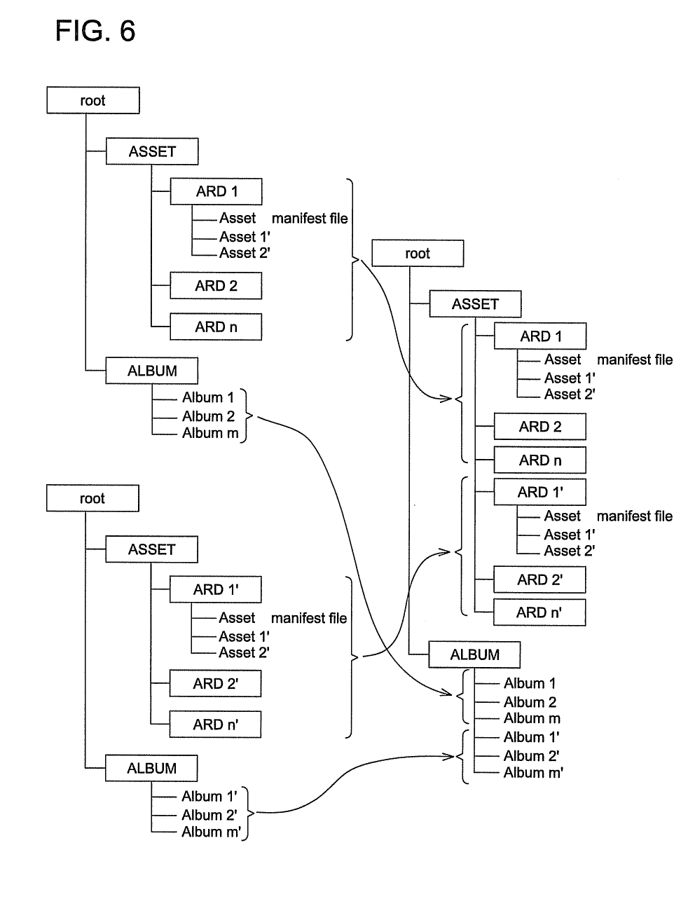

To explain the details of the aforementioned embodiment, the following describes the file or directory name generating method and name generation device as an example of the present invention with reference to FIGS. 1 through 6. FIG. 1 is a block diagram representing the basic structure of the name generation device as an example of the present invention. FIG. 2 is an external view schematically showing the structure of a recording apparatus (kiosk) incorporating the name generation device. FIG. 3 is a flow chart showing a procedure of the name generation method as an example of the present invention. FIG. 4 is a flow chart showing an ID code generation procedure as an example of the present invention. FIGS. 5 and 6 are the diagrams showing an example of the structure of a directory tree.

As shown in FIG. 1, the name generation device 1 of the present example includes:

an asset input unit 2;

a clock unit 5 for generating the time information;

an equipment ID storage unit 6 for storing the information inherent to the device incorporating the name generation device 1 associated with the file or directory inputted from the asset input unit 2;

a name generation unit 3 for generating names to be assigned to the file or directory by using the date information identifiable to the user, such as the imaging date of the image file or the file or directory generation date, this date information being associated with the file or directory inputted from the asset input unit 2; and

a storage unit 4 for assigning the file or directory with the name generated by the name generation unit 3, and for storing the same in the hard disk or recording medium.

The aforementioned unit can be mounted as a hardware on the name generation device 1. However, it can also be structured as a name generation program for allowing a computer to function at least as the name generation unit 3, and this name generation program can be made to run on the name generation device 1.

Further, the name generation device 1 can be implemented by a desired device. For example, when it is mounted on the recording apparatus (kiosk) installed in the Minilab or the like, the structure can be given as shown in FIG. 2. Namely, the image file of the predetermined directory is inputted through the asset input unit 2, wherein this image file of the predetermined directory is recorded on the recording medium (hereinafter referred to as “media IO”) such as Smark Media, Compact Flash, Memory Stick, SD Memory Card and multimedia card, the photographing equipment such as a digital camera 8 and mobile phones with camera 9, or a server 14 connected via the communications network 13 such as the Internet. Then the name of this image file or directory is replaced by the name generated by the name generation unit 3, and is recorded on the recording medium 11 such as the hard disk 12, CD-R/RW, DVD±R/RW, DVD-RAM, HD-DVD and Blu-ray disk by the storage unit 4.

Referring to the flow charts of FIGS. 3 and 4, the following describes the procedure of assigning the name to the file and directory, using the name generation device 1 (recording apparatus 7) of the aforementioned structure. Although the present invention is applicable to a desired type of file, the following describes the cases wherein operation is made to the image file acquired by the digital camera:

In Step S101, the image file of a predetermined directory is inputted by using the asset input unit 2, for example, by loading a medium 10 on the recording medium 1, connecting the digital camera 8, or connecting it to the server 14 via the communications network 13.

Then in Step S102, the name generation unit 3 is used to check the date information associated with the inputted image file such as the imaging date of the image file and generation date. To put it more specifically, the imaging date and generation date are read from the information (e.g. DPOF: Digital Print Order Format information) described in the order information file attached to the image file, and information (e.g., EXIF: Exchangeable Image File Format information) described in the image file. This date information can be the information that can be identified by the user. The file edition date, copy date or user-set date can be employed.

In Step S103, the image files having the same date are extracted from the image files having been inputted, using the name generation unit 3. In Step S104, the image files having been extracted are rearranged in the chronological sequence in the phase of photographing. In this case, the image files of the same date have been extracted, but a desired unit can be used for extracting them up. For example, the distinction between the morning and afternoon can be used as this unit, a week or month can be used as the unit, or the quantity determined in advance can be used as the unit.

In Step S105, a file name is generated for the first file of the same date by the name generation unit 3, according to the aforementioned date information and the ID code set by the recording apparatus 7, and this file name is assigned to the first image file. The method of generating this name will be discussed later. For example, the time information taken out of the clock unit 5 is encoded and a specific code is read out of the MAC address stored in the equipment ID storage unit 6. They are used to generate a unique number, which is then converted into a 36-based code. This is converted into an ASCII code to generate an ID code, which is then assigned with date information to generate a file name. This file name is only required to contain the date information and ID code. If the file name is too long, the aforementioned problem will arise. To avoid this, it is preferred that the length of the file name except for the extension should not exceed 20 bytes.

In Step S106, the ID code of the first image file for the following file of the same date is incremented by “1”. Similarly, date information is added to this ID code to generate a file name. In Step S107, a decision is made to see whether or not there is any image file having the same name as this file name. If there is any, the ID code is again incremented by “1” in Step S108, and the same procedure is repeated. If there is no such image file, this file name is given to the aforementioned file in Step S109.

In the Step S110, a decision is made to see whether or not all the image files of the same date have been processed. If there is any image file not yet processed, the system goes back to the Step S106 and the same procedure is repeated. If all the image files of the same date have been processed, a decision is made in Step S111 to see whether or not all the image files of the different dates have been processed. If there is any image file not yet processed, the system goes back to the Step S103 and the same procedure is repeated.

If all the image files of the different dates have been processed. The image file assigned with the aforementioned name is recorded on the hard disk 12 or recording medium 11 by using the storage unit 4 in Step S112, and a series of the aforementioned operations terminates. It should be noted that the above description refers to the procedure wherein a plurality of image files have been inputted, and the same procedure also applies when a plurality of directories have been inputted.

Referring to the flow chart of FIG. 4, the following describes the details of the procedure of generating the ID code in the Step S105.

In the first place, in Step S201, the name generation unit 3 reads the time information generated by the clock unit 5. For example, assume that time information is HH:MM:SS.CC wherein HH: hour (0-23), MM: minute (0-59), SS: second (0-59), and CC: 1/100 second (0-99). Without being restricted to 1/100 second, the CC can be 1/1000 second unit for extraction.

In Step S202, the name generation unit 3 calculates the time code using the time information having been read. There is no particular restriction to the method of calculating the time code in this case. For example, the following formula can be used for calculation:

T=((CC*100)+SS)*60+MM)+HH (1)

In Step S203, the name generation unit 3 reads predetermined information from the equipment ID stored in the equipment ID storage unit 6. The equipment ID is only required to contain the information inherent to the equipment. The serial number of the equipment can be utilized, but in order to minimize the possibility of duplication of the file name, the MAC address is preferably used. The MAC address (M) is a 6-byte code expressed by the combination between the number inherent to each manufacturer under the management and assignment of the IEEE, and the number assigned to each card uniquely by the manufacturer. It is expressed by M:0-(256´6-1)[256]:[256]:[256]:[256]:[256]:[256](B₁-B₆)

The aforementioned 6-byte codes B₁ through B₃ represent the manufacturer's codes, and the B₄ through re B₆ denote the equipment codes. The ID code of specific byte is read from them. For example, if three bytes—B₃, B₅ and B₆—are extracted from the MAC address, both the manufacturer code and equipment code can be included therein. Then the following formula is used to calculate the value M.

M=B₃*256*256+B₅*256+B₆ (2)

In Step S204, according to the time code generated in the aforementioned Step S203 and the code extracted from the MAC address, the name generation unit 3 calculates the unique number (N_TUID). This unique number (N_TUID) is only required to be calculated based on the aforementioned time code and the code extracted from the MAC address, without any no particular restriction to the method of calculation. For example, when the following formula is used for calculation, the time code can be set on the upper node side bit.

N_{—}TUID=mod((T+M*Tmax),TUIDmax) (3)

where TUIDmax=36⁸ and Tmax=24*60*60*100

Then in Step S205, the name generation unit 3 converts the aforementioned unique number to a 36-based code according to the following formula, whereby “Di” is obtained.

Di=mod(int(N_{—}TUID/36ⁱ),36) (4)

where Di:36-based i-th digit number(0-7.here, LSB=0)

In Step S206, the name generation unit 3 converts Di into the ASCII code representing a 36-based code according to the following correspondence, whereby an ID code is generated. In Step S207, this ID code is assigned with the date information, whereby the name to be given to the file or directory (wherein the length of the name except for the extension is preferred not to exceed 20 bytes) is generated.

0:0, . . . , 9:9,10:A, . . . 35:Z (5)

For example, when the MAC address is 00-80-45-21-85-5E, “YBZZWXW8” will result if this ID code is calculated at 8:30:30.34 (8 o'clock unit, 30 minutes, 30.34 seconds). The data imaged at the same date will be incremented sequentially as in “YBZZWXW9”, “YBZZWXWA” and so on. The ID code calculated 0.01 second thereafter results in “YBZZYSK8”. Even when incremented from the reference TUID during the interval of 0.01 second, there is a continuation of about 320000 frames before an overlap occurs. This arrangement sufficiently reduces the possibility of the file name being overlapped. Especially, the work at the same date is expected to be concentrated in the daytime. When a plurality of jobs are performed collectively, the reference TUID of a very slight time difference will occur. Accordingly, the aforementioned ID code is effectively utilized.

In the aforementioned procedure, time information was given in units of 1/100 second. If the time for one job is expected to be within 1/100 second, it is also possible to create a delay forcibly by the equipment so that calculation is performed after 1/100 second. If the OS (operating system) is characterized by a high timing accuracy, then the time code can be calculated in units of 1/1000 second. Further, the same effect can be obtained when a number (e.g., 0, 1, . . . ) denoting the sequence or model difference is assigned to the lower order bit of the time code instead of increasing the timing accuracy.

The ID portion can be formed according to the time information and each character can be simply subjected to replacement between the upper order bit and lower order bit. For example, when the result of calculating the ID code is “ABCDEFGH”, this may be replaced by “HGFEDCBA”. The date information portion can be replaced as follows: October through December can be replaced by A through C, and 10 through 31 (date) can be replaced by A through V. This arrangement converts “20051228” into “20005CS”, with the result that the length of the name is reduced.

For example, FIG. 5 shows the structure of the data in the hard disk 12 or recording medium 11 wherein the image file has been written in the aforementioned manner. The directory (ASSET) showing the storage position of the image file is generated at the lower order bit position of a predetermined directory (root). The director for storing an image file having a predetermined unit such as the same date is generated at the lower order bit thereof, (this directory being formed in such a way that ARyyyymmdd_xxxxxxxx:yyyymmdd denotes the four-digit year, two-digit month, and two-digit date showing the final imaging date of the image file within the directory or the directory generation date, and xxxxxxxx indicates the 36-based ID codes made up of 0-9 and A-Z generated according to the aforementioned procedure). The image file in predetermined units such as the date in this directory is recorded, (this image file being formed in such a way that ORyyyymmdd_xxxxxxxx:yyyymmdd denotes the four-digit year, two-digit month, and two-digit date showing the imaging date of the image file or generation date and xxxxxxxx indicates the 36-based ID codes made up of 0-9 and A-Z generated according to the aforementioned procedure).

The aforementioned directory tree shows only an example. It is sufficient if at least one of the image file or the directories for storing the image file is assigned with the name generated in the aforementioned manner. In FIG. 5, the date information is set on the upper order bit side of the name, but the ID code can be set on the upper order bit side of the name. Further, only the image file can be recorded on the hard disk 12 or recording medium 11. To facilitate image file management, it is also possible to record the album information that indicates what kind of image file is currently recorded. In this case, the directory (ALBUM) showing the storage location of the album information can be generated, and the album information file (PLyyyymmdd_xxxxxxxx_cccccc:yyyymmdd) assigned with the name in the same procedure can be recorded in this directory, (this album information file being formed in such a way that “PLyyyymmdd_xxxxxxxx_cccccc:yyyymmdd” denotes the four-digit year, two-digit month, and two-digit date showing the date of creating the album, xxxxxxxx indicates the 36-based ID codes made up of 0-9 and A-Z generated according to the aforementioned procedure, and “cccccc” represents a comment). There is no particular restriction to the type of this album information file. It can be a text file, a special-purpose file (pvm format file) recommended in the photo industry, or meta data.

Further, the aforementioned directory tree shows a structure wherein the image file inputted from the digital camera 8 or medium 10 is recorded on a hard disk 12 or recording medium 11. Since overlapping of the names generated by the aforementioned procedure hardly occurs, the image files recorded on a plurality of recording media can be collectively recorded on one recording medium. The directory tree in this case is shown in FIG. 6. A director (ASSET) showing the image file storage site is generated at the lower node side bit of a predetermined directory. The directory and image file recorded on each of a plurality of recording media are recorded at this site. Wherever required, the directory (ALBUM) showing the position for recording the album information file is generated on the lower node side bit. The album information file recorded in each of a plurality of recording media is recorded in this position.

As described above, in the file or directory name generation method and file or directory name generation device of the present example, names are generated using the date information identifiable to the user associated with the file or directory; and the ID code made up of the time information acquired from the clock unit 5, and the equipment ID stored in the equipment ID storage unit 6. This arrangement provides generation of a unique file or directory, and sufficiently reduces the possibility of the file or directory names being overlapped. Further, the time information is set on the upper node side bit of the ID code, and ensures correspondence between the chronological sequence and lexicographic sequence, whereby image file management is facilitated. Further, the aforementioned name is shorter that the name generated according to the UUID and others, and ensures easy display and rearrangement, thereby enhancing the usability. Moreover, the process of calculation is simplified to reduce the load on the name generation device 1.

An image file has been used as an example in the above explanation. It is to be expressly understood, however, that the present invention is not restricted thereto. The present invention can also be applied to other types of files such as music files.

What is claimed is:

1. A name generation method for generating a name to be assigned to a file or directory comprising the step of: combining a date information identifiable to a user with a ID code including the time information for specifying the time of processing, said time information being set on the upper node side bit.

2. The name generation method of claim 1, wherein said date information is the information for specifying the date associated with said file or directory.

3. The name generation method of claim 1, wherein said ID code includes said time information and information specific to an apparatus for implementing said processing.

4. The name generation method of claim 1, further comprising the steps of:
adding or subtracting ID codes contained in names assigned to said files or directories having the same date based on the names for generating new ID codes; and
combining the new ID codes to generate names to be assigned to other said files or directories.

5. The name generation method of claim 1, wherein the length of said name, except for the extension, does not exceed 20 bytes.

6. A name generation device for generating a name to be assigned to a file or directory comprising:
a name generator which generates a name by combination between the date information identifiable to a user, and the ID code including the time information for specifying the time of processing, said time information being set on the upper node side bit.

7. The name generation device of claim 6 wherein said date information is the information for specifying the date associated with said file or directory.

8. The name generation device of claim 6, wherein said ID code includes said time information and information specific to an apparatus for implementing said processing.

9. The name generation device of claim 6, wherein the name generator generates new ID codes by adding or subtracting ID codes contained in names assigned to said files or directories having the same date based on the names and combining the new ID codes to generate names to be assigned to other said files or directories.

10. The name generation device of claim 6 wherein the length of said name, except for the extension, does not exceed 20 bytes.
